(19) United States
(12) Patent Application Publication
(10) Pub. No.: US 2009/0145592 A1
(43) Pub. Date: Jun. 11, 2009

(54) Windshield washer fluid heating system

(76) Inventors: Frank Joseph Leitch, North Tonawanda, NY (US); Brian J. Coyle, Orchard Park, NY (US)

Correspondence Address: DELPHI TECHNOLOGIES, INC., M/C 480-410-202, PO BOX 5052, TROY, MI, 48007, US

(21) Appl. No.: 12/001,185

(22) Filed: Dec. 10, 2007

(51) Int. Cl. F28F 7/00; B60H 1/02; B65D 88/74; F01P 1/06

(52) U.S. Cl. 165/185; 165/44; 165/51; 220/592.28

(57) ABSTRACT

The invention provides a system for capturing waste heat from a heat source via an air cooled radiator to heat a container of windshield washer fluid in a motor vehicle. The system's components include a radiator, means to induce air flow through the radiator, and a shroud assembly for mounting a windshield washer fluid container downdraft of the radiator. The shroud assembly includes a radiator shroud that is adapted to mount onto the radiator to define a plenum for receiving heated air and a windshield washer fluid container. The windshield washer fluid container may be formed with the radiator shroud as a single integral unit. On the container surface is a heat conductive element that is in direct contact with both the heated air flow and windshield washer fluid.

### TECHNICAL FIELD OF INVENTION

The invention relates to a windshield washer fluid heating system; more particularly, a radiator shroud having a windshield washer container with an integrated heat conductive element for capturing waste heat from a radiator.

### BACKGROUND OF INVENTION

In a typical automobile having an internal combustion engine, the windshield washer container is located within the engine compartment. The windshield washer solution is typically not heated. It is desirable for the windshield washer solution to be heated, because for every 10° C. rise in temperature of the solution, the cleaning potency of the solution is doubled. The improved cleaning power of the heated solution efficiently removes dead insects, dust, salt, oil, and other road residuals that may accumulate on the windshield and head lamps on an automobile. Heated windshield washer solution in the winter provides the convenience of releasing frozen wiper blades, unblocking wiper nozzles, and aids in the removing of ice and snow build-up on the windshield.

In higher end automobiles, there exist various systems to heat the windshield washer solution for improved cleaning properties and for improved deicing capabilities in freezing temperatures. U.S. Pat. No. 3,888,412, issued to Herbert Lindo, discloses a windshield washer system in which a heat exchanger is disposed within the windshield washer fluid container. The heat exchanger is supplied with non-contact heated coolant through a hose from the radiator of the vehicle. The heated coolant provides heat to the windshield washer fluid via the heat exchanger prior to returning to the radiator. Another known variation of the above mentioned system, is an electrical heater element disposed within the windshield washer container in lieu of the non-contact coolant heat exchanger.

In the non-contact liquid to liquid heat exchanger, there is the added complication and cost of extra plumbing and connectors. Another drawback to the above mentioned systems is the added complexity of a liquid heat exchanger or an electrical heating element disposed in the windshield washer container, which could lead to cross fluid contamination or fouling of the heater element. The increased complexity of the systems results in greater potential leak points, electrical failures, and higher cost.

What is needed is a simple system that can recapture and utilize waste heat from a heat source, such as an internal combustion engine, battery pack, or fuel cell to heat windshield washer fluid without added complex plumbing or electrical systems.

### SUMMARY OF THE INVENTION

The invention provides a system for capturing waste heat from a heat source via an air cooled radiator, to heat a container of windshield washer fluid in a motor vehicle. The system's components include a radiator, means to induce air flow through the radiator, and a support structure for mounting a windshield washer fluid container downstream of the radiator. The waste heat released into the air flow from the radiator is used to heat the windshield washer fluid in the container. For increased heat transfer efficiency from the heated air to the windshield washer fluid, the container has a face with an integrated heat conductive element that is faced toward the oncoming heated air flow. The support structure can be part of a radiator shroud assembly adapted to mount onto the radiator.

The shroud assembly includes a radiator shroud that is adapted to mount onto the radiator to define a plenum for receiving heated air and a windshield washer fluid container. The windshield washer fluid container may be formed with the radiator shroud as a single integral unit. On the container surface is a heat conductive element that is in direct contact with both the heated air flow and windshield washer fluid.

Located downstream of the radiator is a fan assembly that creates a low pressure zone which induces air flow through the passageways of the radiator. As hot coolant flows through the radiator tubes, heat is transferred from the hot coolant to the induced air stream. As the air flow is guided through the plenum, the heated air flow impinges upon a heat conductive element of the container, thereby transferring heat to the windshield washer fluid held in the container.

An alternative container embodiment has a reservoir chamber with an inverse “L“shape for increased windshield washer fluid storage capacity and an outlet chamber abutted against the reservoir chamber. The alternative container also has a plurality of substantially parallel flow tubes hydraulically connecting the reservoir chamber to the outlet chamber. The flow tubes are spaced apart providing a passageway for air flow therebetween. Located in the space provided are heat conductive elements such as interlacing fins for increased heat transfer efficiency

Located on top of the reservoir chamber is an inlet for the windshield washer fluid. As the reservoir chamber is filled, the windshield washer fluid flows within the parallel tubes to the outlet chamber. Connected to the outlet chamber is a tube that is connected to a pump to transfer the fluid from outlet chamber to the windshield or head lamps on demand. As heated air flows through the space between the parallel tubes, the fins transfer heat from the air flow to the windshield washer fluid located in the flow tubes.

One advantage of the invention is that waste heat from the radiator is captured to heat windshield washer fluid; thereby providing increased cleaning potency of the fluid and reducing the operating temperature in the engine compartment.

Yet another advantage of the invention is that complex electrical components or additional plumbing are not needed to provide heated windshield washer fluid; thereby, saving cost and freeing up valuable space in the engine compartment of a motor vehicle.

Yet another advantage of the invention is that the windshield washer container may be integrally formed with the fan shroud; thereby, saving cost and time in manufacturing.

Further features and advantages of the invention will appear more clearly from the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a perspective view of a radiator shroud assembly with an attached windshield washer container.

FIG. 2 is a partial perspective view of a radiator shroud with the windshield washer container expanded from the radiator shroud with a heat conductive plate in-between.

FIG. 3 is a cross-sectional view of a radiator shroud having an attached windshield washer container along line A-A of FIG. 1.

FIG. 4 is a cross sectional view of an alternative embodiment of a radiator shroud having an attached windshield washer container mounted between the radiator shroud and radiator.

FIG. 5 is a cross section of the windshield washer container with an integrally molded heat conductive plate.

FIG. 6 is an alternative embodiment of a windshield washer container mountable to the radiator shroud shown in FIG. 2 in lieu of the heat conductive plate.

FIG. 7 is a Temperature vs. Elapsed Time graph of the increase in temperature of the windshield washer fluid at 30° F. ambient air.

FIG. 8 is a Temperature vs. Elapsed Time graph of the increase in temperature of the windshield washer fluid at 70° F. ambient air.

### DETAILED DESCRIPTION OF INVENTION

The invention relates to a system of components for capturing waste heat from an air cooled heat exchanger to heat windshield washer fluid for a motor vehicle. The air cooled heat exchanger is of a fin and tube core radiator that is part of a closed loop system used to remove excess heat from the internal combustion engine or other heat source, such as a battery pack or fuel cell, of an automobile.

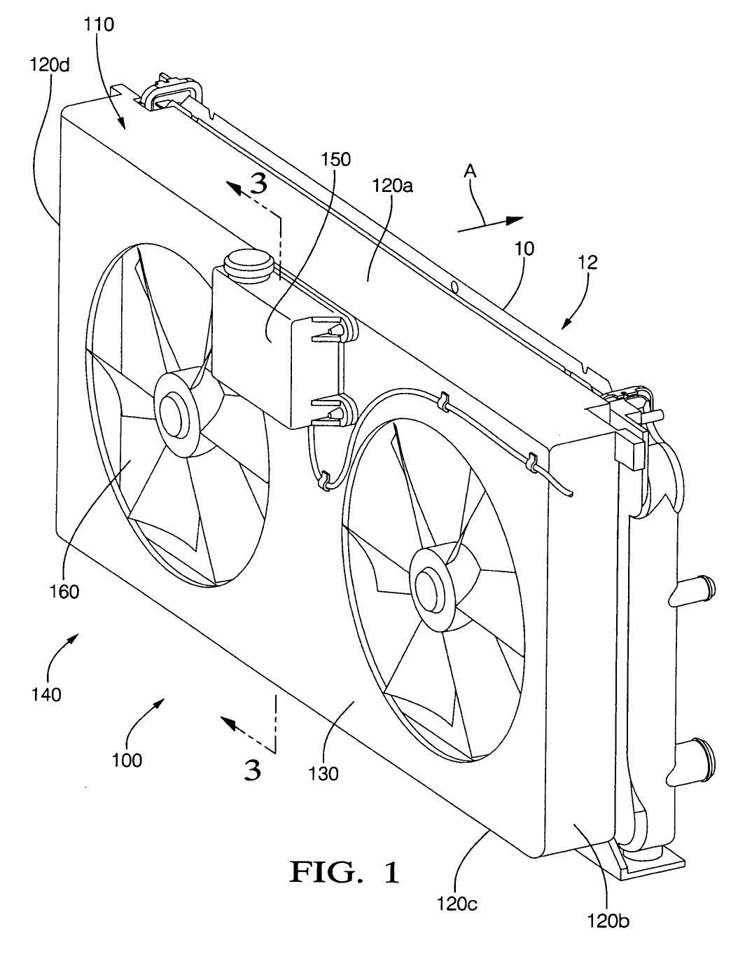

Shown in FIGS. 1 through 4 is a preferred embodiment that generally includes a radiator shroud assembly 100 having a windshield washer fluid container 150 with an integrated heat conductive element 170 adapted to mount downstream of radiator 10.

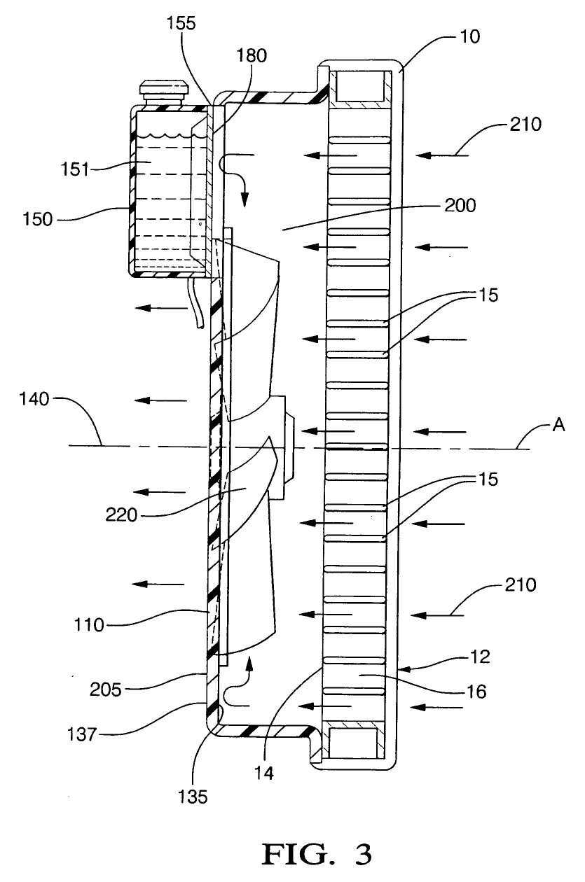

Shown in FIG. 3 is a cross sectional view of radiator shroud assembly 100 taken along section line A-A in FIG. 1. Shown is a cut-away view of radiator 10 having a first face 12, a second face 14 opposing first face 12, and a plurality of substantially parallel tubes 15. A bank of tubes 15 forms a central core hydraulically connecting end tanks 11 for hot coolant flow from one end tank to the other. Tubes 15 are spaced apart forming passageways 16 for induced ambient air flow 210. Interlaced in the space between tubes 15 are heat transfer elements, such as corrugated metallic fins (not shown), for increased heat transfer from the hot coolant to the cooler ambient air flow 210.

Radiator shroud 110 is substantially rectangular having four side walls 120a, 120b, 120c, 120d integrally formed with back wall 130 to define interior surface 135. Interior surface 135 is oriented toward second face 14 of radiator 10. Radiator shroud 110 includes exterior surface 137 opposing radiator 10 and a center longitudinal axis 140 that is perpendicular to back wall 130. Attached to back wall 130 is windshield washer container 150 that contains the windshield washer fluid 151. Also shown in FIG. 3 is plenum 200 for guiding air flow 210 defined by the space between interior surface 135 of radiator shroud 110 and second face 14 of radiator 10. Back wall 130 of radiator shroud 110 also includes at least one opening 160 that is adapted to allow the release of air flow 210 from plenum 200.

The rectangular shape of radiator shroud 110 is shown for illustrative purposes only; therefore, is not meant to be limiting. Radiator shroud 110 can be of any shape, manufactured by any of the known methods in the art, as well as by any known material as long it provides the rigidity and strength necessary to support the novel features of the instant invention, which is described in detail herein. As such, the shroud can be manufactured by compression or blow molded plastic, fabricated or stamped metal, or any combination of the above.

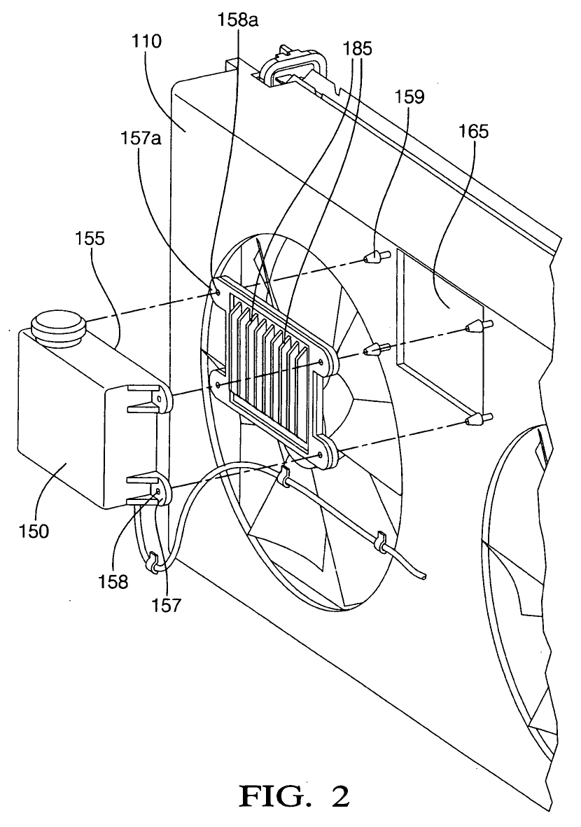

Shown in FIG. 2 is an exploded view of the windshield washer container 150 detached from back wall 130 of radiator shroud 110. Windshield washer fluid container 150 has open face 155 that is oriented toward second face 14 of radiator 10. Open face 155 is adapted to engage with heat conductive element 170 to form a liquid tight seal, which will be described in detail herein below. Located on back wall 130 is vent 165. Located on each corner of windshield washer fluid container 150 are extended bosses 157 having grommets 158 for attaching windshield washer container 150 to back wall 130 with fasteners 159.

Heat conductive element 170 may be that of a heat conductive plate 180. Container open face 155 is adapted to engage with heat conductive plate 180 to form a liquid tight seal. The liquid tight seal may be formed by over-molding container 150 around the edges of conductive plate 180, as shown in FIG. 5, or mating conductive plate 180 onto contacting surfaces of container 150 with a known gasket materials. The heat conductive plate 180 has bosses 157a with grommets 158a that coincide with the bosses 157 and grommets 158 of container 150. The heat conductive plate 180 is sufficiently large in surface area to partially, if not totally, obstruct vent 165.

Heat conductive plate 180 is formed of a material having a higher heat transfer coefficient than that of container 150. Preferably, heat conductive plate 180 is formed of a metal such as copper. To increase the surface area of heat conductive plate 180, plate fins 185 or other protruding features may be incorporated on either surface. Windshield washer fluid 151 within container 150 is in direct contact with heat conductive plate 180 for optimal transfer of heat from the heated air flow to the fluid.

Windshield washer container 150 can be integrally molded into radiator shroud by utilizing the same material as radiator shroud 110. Heat conductive element 170, such as a heat conductive plate 180, can be later incorporated to the common surface of radiator shroud 110 and container 150 to form a liquid tight windshield washer container.

Located downstream of radiator 10 is fan assembly 220 which creates a low pressure zone which induces air flow through passageways 16 of radiator 10. Radiator shroud 110 may be adapted to accommodate fan assembly 220 or fan assembly 220 may be mounted on a separate support structure (not shown). As an alternative, fan assembly 220 may be mounted in a separate structure which is located upstream of radiator 10 toward the front of the automobile.

The operation of the radiator shroud assembly 100 to heat windshield washer fluid in windshield washer container 150 will be described in reference to FIG. 3. As heated coolant flows through passageways 16 between radiator tubes 15, heat is transferred from the hot coolant to air flow 210. As air flow 210 is guided through plenum 200, heated air flow 210 impinges upon heat conductive element 170. Shown in FIG. 3, heat conductive element 170 is a flat heat conductive plate 180 which is in direct contact fluid within container 150. Heat is transferred from radiator 10 to heat conductive plate 180 by convection; in turn, heat is transferred to windshield washer fluid 151 from heat conductive plate 180 by conduction and convection.

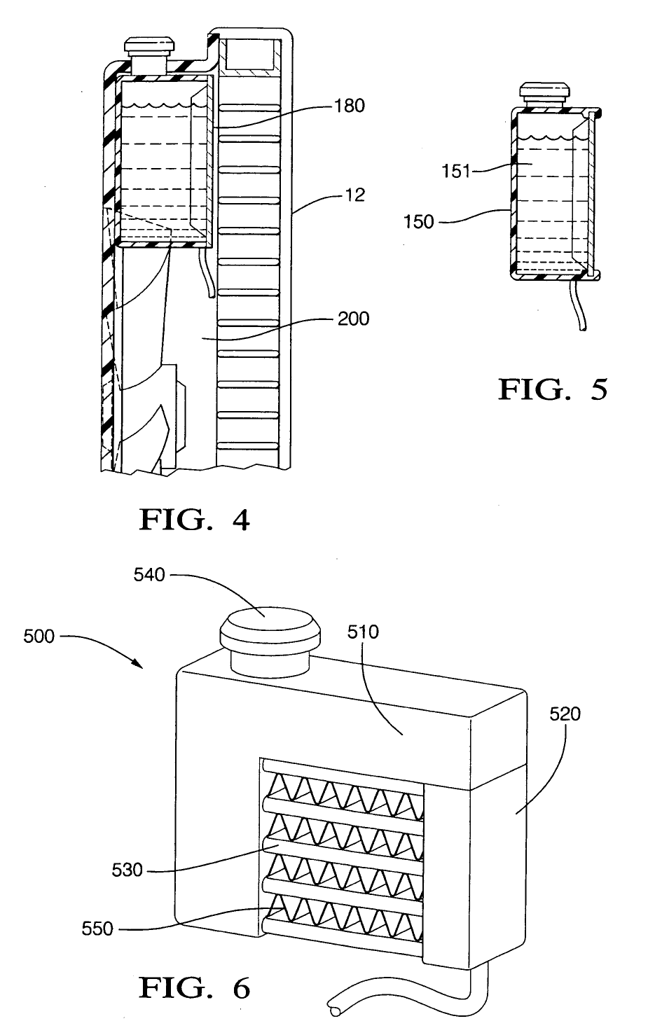

As an alternative arrangement, shown in FIG. 4, container 150 may be located between interior surface 135 of radiator shroud 110 and second face 14 of radiator 10 as shown in FIG. 4. Heat conductive plate 180 may be in direct contact with second face 14 for heat transfer via conduction as well as convection.

Shown in FIG. 6 is an alternative embodiment of windshield washer fluid container 150 for use with radiator shroud assembly 100. Alternative container embodiment 500 has a reservoir chamber 510 that is hydraulically connected to outlet chamber 520 by a plurality of substantially parallel tubes 530. Parallel tubes 530 are vertically spaced apart providing a pathway for heated air from the radiator to flow between the tubes. To facilitate heat transfer to the windshield washer fluid, positioned between the tubes are fins made of a higher heat conductive material such as metal.

Reservoir chamber 510 has an inverse “L” shape for increased fluid storage capacity. Located on top of the reservoir chamber 510 is inlet 540 for the windshield washer fluid. As the reservoir chamber 510 is filled, the windshield washer fluid flows across parallel tubes 530 to outlet chamber 520. Connected to outlet chamber 520 is a tube that is connected to a pump (not shown) that transfers the windshield washer fluid from outlet chamber 520 on demand. As heated air flows through the spacing between the parallel tubes 530, fins 550 transfer heat from the air flow to the windshield washer fluid located in the flow tubes 530.

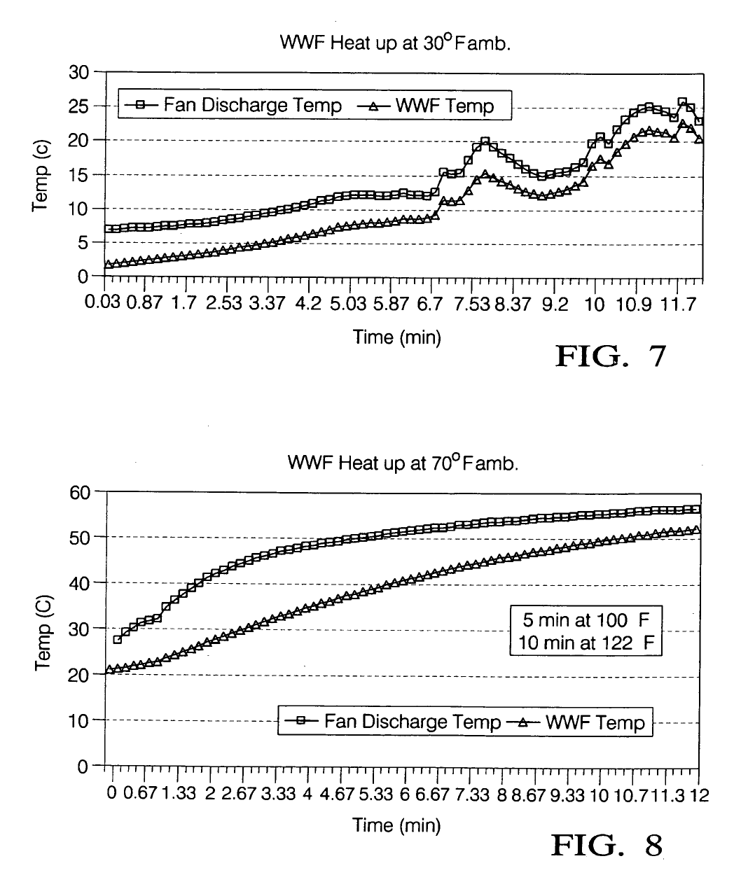

Shown in FIGS. 7 and 8 are Temperature vs. Elapsed Time graph of the increase in temperature of the windshield washer relative to the temperature of the heated air. The temperature of the fluid is measured at the container and the temperature of the heated air is measured at the discharge of the radiator shroud. The volume of fluid heated is approximately 1 gallon, which is typical of the volume contained in an automotive windshield washer container.

In reference to FIG. 7, at an ambient temperature of 30° F., which is below the freezing point of water at 1 atmosphere pressure, shown is the increase in temperature of the fluid corresponding to the increase in the heated air temperature. Within 5 minutes of start-up, the fluid temperature increase to 40° F. (4.4° C.), which is sufficient for de-icing purposes.

FIG. 8 is a Temperature vs. Elapsed Time graph of the increase in temperature of the windshield washer fluid at 70° F. (21° C.) ambient air. At 5 minutes after start-up, the temperature of the washer fluid is 100° F. (38° C.) which is sufficient for bug removal. At 10 minutes after start-up, the fluid is 120 ° F. (48° C.). Research has shown that an increase of 10° C. will double the cleaning effectiveness of the fluid.

While this invention is described in terms of heating windshield washer fluid, it should be noted that this system can also be used to heat various other fluids that are present in a motor vehicle such as transmission oil; therefore, it is not intended to be limited windshield washer fluids.

Furthermore, while a fan assembly is described to induce air flow through passageways of the radiator, other means can be utilized to create the desired air flow. Other means can include the forward motion of the motor vehicle moving through ambient air.

Still furthermore, while this invention has been described in terms of the preferred embodiments thereof, it is not intended to be so limited, but rather only to the extent set forth in the claims that follow.

We claim:

1. A system for heating windshield washer fluid, comprising:
an air cooled heat exchanger having a first face, a second face opposing said first face, and passageways connecting said first face with said second face;
means for inducing air flow through said passageways from said first face to said second face;
a support structure adapted to mount onto said heat exchanger; and
a container attached to said support structure, wherein said container has a heat conductive element disposed in path of said air flow exiting from said passageways.

2. A system for heating windshield washer fluid of claim 1, wherein said support structure is a radiator shroud comprising:
an interior surface adapted to face toward said second face of radiator;
an exterior surface opposite of said interior surface; and
at least one opening connecting said interior surface with said exterior surface for passage of air;
wherein said heat conductive element at least partially obstructs said opening.

3. A system for heating windshield washer fluid of claim 2, wherein said container comprises:
a reservoir chamber having a substantially inverse “L” shape profile;
an outlet chamber abutted against said reservoir chamber; and
a plurality of substantially parallel tubes hydraulically connecting said reservoir chamber with said outlet chamber;
wherein said heat conductive element include fins positioned between said tubes.

4. A system for heating windshield wash fluid of claim 3, wherein said container is attached to said exterior surface of said radiator shroud.

5. A system for heating windshield washer fluid of claim 3, wherein said container is attached to said interior surface of said radiator shroud.

6. A system for heating windshield washer fluid of claim 2, wherein said heat conductive element is a metallic plate.

7. A system for heating windshield washer fluid of claim 6, wherein said metallic plate is in contact with said second face of heat exchanger.

8. A shroud assembly for use with a radiator to transfer heat from an air flow to a fluid, comprising:
a radiator shroud adapted to mount with said radiator to define a plenum for receiving heated air flowing from said radiator, wherein said radiator shroud includes at least one opening for releasing said heated air from said plenum; and
a container for holding windshield washer fluid mounted on said radiator shroud facing said radiator, wherein said container includes a heat conductive element in contact with said container and said heated air flow;
whereby said heated air flow from said radiator flowing through the plenum is in contact with said heat conductive element to transfer heat to said windshield washer fluid.

9. A shroud assembly as in claim 8, wherein said radiator shroud has a first heat transfer coefficient and said heat conductive element has a second heat transfer coefficient that is greater than said first heat transfer coefficient.

10. A shroud assembly as in claim 9, wherein said radiator shroud further comprises:
an exterior surface opposing said radiator;
an interior surface opposite of said exterior surface facing said radiator; and
an opening for hydraulic communication between said exterior surface and interior surface;
wherein said container is mounted on said exterior surface at least partially obstructing said opening.

11. A shroud assembly as in claim 10,
wherein said heat conductive element comprises a metallic plate facing toward said radiator.

12. A shroud assembly as in claim 10, wherein said container further comprises:
a reservoir chamber having an inlet for windshield washer fluid,
an outlet chamber having an outlet; and
a plurality of substantially parallel flow tubes hydraulically connecting said reservoir chamber to said outlet chamber, wherein said flow tubes are spaced apart proving a passageway for air flow;
wherein said heat conductive element comprises fins interlacing space between said flow tubes.

13. A shroud assembly as in claim 9, wherein said radiator shroud further comprises an interior surface facing said radiator, and wherein said container is mounted onto said interior surface with said heat conductive element adapted to face toward said radiator.

14. A shroud assembly as in claim 9, wherein said heat conductive element comprises a metallic plate.

15. A shroud assembly as in claim 14, wherein said metallic plate is adapted to contact said radiator.

16. A radiator assembly for using waste heat from a radiator to heat windshield washer fluid, comprising:
a radiator assembly having a center axis, a first face, an second face, a plurality of tubes perpendicular to said center axis for coolant flow, fins between said tubes for increased heat transfer area, and passageways for axial air flow between said fins;
a rotatable fan having a plurality of blades disposed axially from said radiator assembly for inducing air flow through said radiator assembly;
a radiator shroud having protruding side walls demarcating an inner surface and an outer surface, wherein said radiator shroud partially surrounds said fan and said side walls engage with said radiator defining a plenum therebetween said second face of radiator assembly and said inner surface of radiator shroud;
a windshield washer container mounted onto said radiator shroud and axially spaced from said radiator assembly, wherein said windshield washer container includes a heat conductive surface in pathway of said air flow.

17. A radiator assembly for using waste heat from a radiator to heat windshield washer fluid as in claim 16, wherein said heat conductive surface is a metallic plate.

18. A radiator assembly for using waste heat from a radiator to heat windshield washer fluid as in claim 16, wherein said windshield washer container further includes:
a reservoir chamber having a substantially inverse “L” shaped profile;
an outlet chamber abutted against reservoir chamber; and
a plurality of substantially parallel tubes hydraulically connecting said reservoir chamber with said outlet chamber;
wherein said heat conductive element include fins positioned between said tubes.

19. A radiator assembly for using waste heat from a radiator to heat windshield washer fluid as in claim 18, wherein said radiator shroud further includes:
an exterior surface opposing said radiator assembly;
an interior surface opposite of said exterior surface facing said radiator; and
an opening for hydraulic communication between said exterior surface and interior surface;
wherein said container is at least partially obstructing said opening.

20. A radiator assembly for using waste heat from a radiator to heat windshield washer fluid as in claim 19, wherein said container further includes:
a reservoir chamber;
an outlet chamber abutted against reservoir chamber; and
a plurality of tubes hydraulically connecting said reservoir chamber with said outlet chamber;
wherein said heat conductive element include fins positioned between said tubes.

21. A windshield washer fluid container adapted to mount downstream of an air cooled radiator, comprising:
a reservoir chamber having an inlet, wherein said reservoir chamber has a substantially “L” shaped profile;
an outlet chamber having an outlet, wherein said outlet chamber is adjacent to reservoir chamber; and
a plurality of substantially parallel tubes hydraulically connecting said reservoir chamber with said outlet chamber, wherein said tubes are spaced apart; and
fins positioned between said tubes, wherein said fins are corrugated metal.
